(19) United States
(12) Patent Application Publication
(10) Pub. No.: US 2003/0069731 A1
(43) Pub. Date: Apr. 10, 2003

(54) Adaptive navigation method in an interactive voice system, and interactive voice navigation system

(76) Inventor: Albert Foucher, Versailles (FR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/243,954

(22) Filed: Sep. 16, 2002

(30) Foreign Application Priority Data
Sep. 14, 2001 (FR) 01 11931

(51) Int. Cl. G10L 15/04

(52) U.S. Cl. 704/251

(57) ABSTRACT

Adaptive navigation in an interactive voice system is attained with an engine recognizing the spoken words of a user, a voice application stored in a memory of a central processing unit of a data system and managing, by a dialog manager, the dialog with the user through a voice interface as a function of the implemented recognition. The ergonomics of the dialogs with the user is dynamically managed as a function of plural indicators.

### FIELD OF INVENTION

The present invention relates to an adaptive navigation method in an interactive voice system, to an interactive voice navigation system and the application of this voice system.

### BACKGROUND ART

A voice navigation system is used in known manner in the field of mobile telephony. A user of a mobile terminal situated in a radio cell of a base station can access from his/her terminal one or more voice services. As desired, the user can communicate directly with a physical person, called the remote actor, or with an interactive voice system. These interactive voice systems allow the user to navigate between personalized services, for instance by selecting keys on the keypad of his/her mobile terminal. The user may wish to consult his/her last bill, to change his/her rate or to immediately consult a remote person to acquire information or to make changes that cannot be made through the keypad of his/her mobile terminal. Other voice navigation systems also exist which make it possible to react and to directly reply to user questions without resorting to a remote person.

In the prior art, these systems include a voice recognition engine associated with a plurality of vocabulary and grammar tables including words or expressions that are recognized by the engine, and a voice application, also called service logic, to manage the dialogs with the user by use of a voice interface. The quality of the recognition implemented by the voice recognition engine substantially affects the voice system's potential. However, for user comfort, a service logic also is required to provide the user with satisfactory service. Prior art systems employ service logics that ignore user behavior entirely or substantially. They poorly manage the user's listening stance, the dialog often being too terse for a novice user or too voluble for an experienced one. Moreover, the prior art system ignores defective comprehension and therefore is subject to repetition and loops. The prior art system does not match the dialog to the user's reasoning processes.

An object of the present invention is to create a new and improved voice navigation method and apparatus that is free of the drawbacks of the prior art.

### SUMMARY OF THE INVENTION

According to one aspect of the invention, an adaptive navigation method in an interactive voice system includes an engine for recognizing spoken user words, and a voice application which is stored in a memory of a central processing unit of a data system. The processor manages (a) user dialog through a voice interface as a function of the implemented recognition, and (b) dynamically manages ergonomics of the dialogs with the user to adjust the voice application as a function of a plurality of indicators that relate to user behavior and are represented by data stored in a memory of the processor.

In another feature of the present invention, the processor performs a recognition analysis which is carried out as a function of the analysis and the state of at least one indicator that triggers an action managed by the voice application.

In another feature of the present invention, the action may be any of (1) transmission of a reply to the user's spoken words, (2) request to a user to repeat the words, (3) asking the user to speak, (4) relay the user to a consultation with a physical person, or (5) modifying assistance to be provided to the user.

In another feature, a request to confirm the implemented recognition is sent prior to the initiation of the action.

In yet another feature of the present invention, the said method includes storing and adapting the dialog as the user progresses by storing in several counters of the processor (1) a first indicator representing the user's dialogue level, (2) a second indicator based on dialog quality and (3) a third indicator representing the history of the dialog with the user.

In yet another feature of the present invention, a dialog-level counter is incremented to modify the assistance level.

In still another feature of the method of the present invention, a non-responding counter is incremented in response to the value stored therein being below a maximum value, to trigger a transmission to the user requesting the user to talk.

In another feature of the present invention, an incomprehensibility counter is incremented in response to the state of the counter being less than a maximum value, to trigger a transmission that asks the user to repeat.

Another aspect of the invention includes an interactive voice navigation system comprising an engine for recognizing a user's spoken words, a voice application stored in a central memory unit of a data processor system and managing by dialog managing arrangement the dialog with the user through a voice interface as a function of implemented recognition. The system includes a dynamic managing arrangement for the dialog ergonomics relating to the user in order to adjust the voice application as a function of a plurality of indicators relating to user behavior and represented by data stored in the memory of the central unit.

In another feature of the present invention, said system analyzes the implemented recognition and initiates an action managed by the voice application as a function of both the recognition analysis that was carried out and the state of at least one indicator.

In another feature of the present invention, the system works out and transmits a reply to user spoken words, works out and transmits requests to confirm the implemented recognition, develops and transmits a request to a user to repeat his/her spoken words or to speak, shifts the dialog to a physical person and regulates the level of help extended to the user.

In another particular, the system derives a first indicator representing the level of the user's spoken words, a second indicator representing dialog quality and a third indicator representing the history of dialog with a user.

In yet another particular, each indicator is associated with at least one stored counter, the value of which gradually changes as the dialog with the user progresses.

In still another particular, the first indicator is stored in a so-called dialog-level counter in a memory of the central processor unit, so that, when the value in the counter is added to or subtracted from, the count triggers a change in help level for the user.

In still another particular, two counters correspond to the first indicator, namely a first local so-called incomprehensibility counter and a second local so-called non-response counter; both counters are included in the central unit's memory.

In yet another particular, a third indicator corresponds to a so-called general history counter included in the central unit's memory.

In yet another particular, the dialog-level counter assumes values from 0 to 4.

In yet another particular, the incomprehensibility counter assumes values from 0 to a value exceeding its maximum stored value of 2.

In yet another particular, the non-response counter assumes values from 0 to a value exceeding its stored maximum value of 2.

In yet another particular, the general history counter assumes values from 0 to a value exceeding its maximum stored value of 3.

The present invention also relates to applying the above described voice system to a mobile telephony system.

The above and still further objects, features and advantages of the present invention will become apparent upon consideration of the following detailed description of one specific embodiment thereof, especially when taken in conjunction with the accompanying drawings.

### BRIEF DESCRIPTION OF THE DRAWING

FIG. 1 is a schematic diagram of a voice navigation system according to a preferred embodiment of the present invention, and

FIG. 2 is a flow diagram of an algorithm used in the voice navigating system of FIG. 1.

### DETAILED DESCRIPTION OF THE DRAWING

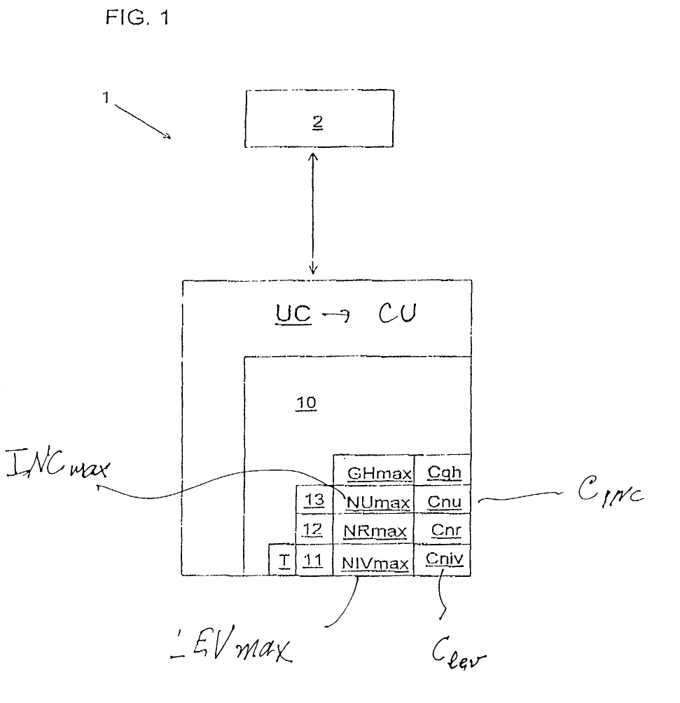

The system of FIG. 1 manages in a dynamic and evolutionary manner the relationship between a voice system which is implanted into a communications network and the user connected to a network by any such means as a telephone or computer. If, for instance, the user is connected by a wireless telephony network to the voice navigation system 1 which comprises at least one memory 10 for instance belonging to a central processor unit CU of a data system as shown in FIG. 1, such user is guided and helped in a flexible way by what is called a user context in particular as a function of the user's knowledge, the user's search competence and the quality of the exchanges. The memory can include one or several units and be of all kinds, namely RAM, ROM, PROM, EPROM.

The voice navigation system of FIG. 1 comprises a voice interface 2 for receiving and sending voice data, that are in analog form. The system of FIG. 1 also includes a speech recognition engine 11. Illustrated engine 11 is integrated into the central processor unit CU of a data system and recognizes user speech throughout the network. For that purpose speech recognition engine 11 includes grammar and vocabulary tables T stored for instance in the memory 10 of central processor unit CU. The recognition engine 11 receives the previously digitized data and thereupon, by consulting the tables, attempts to link the data to a letter or a syllable to reconstitute a word or a sentence.

A voice application 12, also called service logic, also is stored in memory 10 of central processor unit CU. Voice application 12 manages the dialog with a user by using dialog management tools. Analysis engine 13, illustratively integrated into central processor unit CU, analyzes data received from the voice recognition engine 11. This analysis includes understanding the meaning of the user's spoken words. As a function of this analysis and using the dialog management tools, voice application 12 determines and synthesizes appropriate answers and sends them to the voice interface 2 to be reproduced and communicated to the user. These dialog management tools are instructed by voice application 12 to search the tables T for diverse information that is combined to construct the answer or a complementary question and to send this answer or complementary question to the voice interface 2 where it is reproduced.

A session is defined hereafter as being a single communication between the user operating his/her telephone or computer and the voice navigation system implanted in the network. Accordingly during one session, the user may ask several independent questions to the voice navigation system 1.

To follow the progress of the user's navigation, a context user is associated with the user in a system memory. This context accompanies the user during the full session and causes voice application 12 to appropriately react to the user behavior and to the history of the session.

This user context includes a first indicator for the user level determined by the quality of the user's spoken words. During communication with the voice navigation system 1, the user's spoken words are in a more or less precise language. This first indicator is linked to another indicator, taking into account the level of help to be given this user. Depending on the user's dialog level, more or less help, that is more or less detailed explanations, are offered to him/her.

The user context also comprises a second indicator which is based on the dialog quality between the user and the voice navigation system. This indicator takes into account the non-responses from the user or the incomprehensibility perceived by the voice navigation system.

The user context furthermore includes a third indicator which is based on the user dialog history of one session.

Each indicator is associated with a counter included, for instance, in memory 10 of the central processor unit CU. The count stored in each counter increases or decreases as a function of user behavior. In the course of a session, these counters provide dynamic adjustment of the user context as a function of user behavior.

Dialog-level counter Cₗₑᵥ corresponds to the first user level indicator. This dialog level counter Cₗₑᵥ is a counter having a count which changes over a full session. During a session counter Cₗₑᵥ evolves (i.e., is incremented-and/or decremented) between 0 and a stored maximum value LEVmax, stored for instance in the memory 10 of the central unit CU. Illustratively this maximum value is 4. Each value Cₗₑᵥ assumed by the counter is associated with a different help level to be extended to the user. As value stored in dialog level counter Cₗₑᵥ rises incrementally, the explanations offered by the voice navigation system become more detailed. During one session, the value stored in dialog level counter Cₗₑᵥ increases twice as fast as it decreases to make sure that proper help is always extended to the user.

Two distinct counters correspond to the second indicator, namely a so-called incomprehensibility counter C_{inc} and a non-response counter Cnr. The value stored in incomprehensibility counter C_{inc} rises in increments in response to outputs of the voice application 12 signaling each time a user is unable to comprehend use of voice navigation system 1. The value stored in non-response counter Cnr rises in increments in response to outputs of voice application 12 signaling each user non-response to a question asked by the voice navigation system 1. These two counters are local, that is, they do not count for a full session but, for instance, merely within the scope of a question raised by the user. These counters are included in a memory of the central processing unit CU and may vary between 0 and values exceeding maximum values which are respectively INCmax and NRmax. These maximum values INCmax, NRmax are typically stored in memory 10 of central processor unit CU. Each stored maximum value is illustratively 2.

A general history counter Cgh corresponds to the third indicator which is based on the dialog history. In the course of one session, the voice application 12 increments and/or decrements the value this counter stores as a function of events as discussed infra as the dialog progresses between user and voice navigation. The value general history counter Cgh stores can vary between 0 and a value exceeding a maximum value GHmax. This maximum value GHmax for instance is stored in the memory 10 of central processor unit CU and is illustratively 3. When voice application 12 senses that this maximum value has been exceeded, the communication is switched to a remote actor. The maximum value GHmax is set so that, in case of recurring problems, switching is performed before the user hangs up.

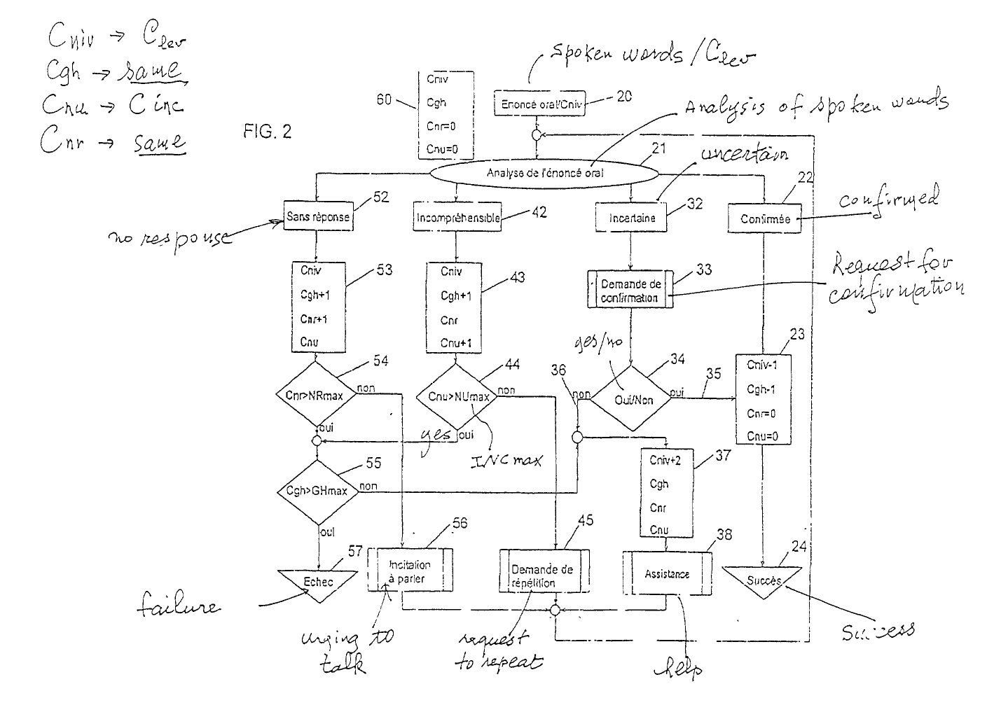

The voice navigation method proceeds as shown by the flow chart of FIG. 2.

Illustratively a mobile terminal user situated within the cell of a base station calls the voice navigation service of FIG. 1. At the beginning of a session, all counters 60 are initialized at 0, in particular the dialog level counter Cₗₑᵥ that controls the level of help. Following a welcome message transmitted by the voice navigation system, the user delivers first spoken words, for instance in the form of a question 20. At the very beginning, question 20 is recognized by the voice recognition engine 11 which transmits the recognized sentence to the analysis engine 13 which, in a first stage 21 common to all questions, analyzes the meaning of this sentence. This user question is termed the main question 20. Following success, that is the transmission of a reply by the voice navigation system 1 to a main question 20, the user might ask a new independent question. Therefore, during one session, and if so desired, the user may raise several independent main questions. At the beginning of each main question 20, the local incomprehensibility counters 60, C_{inc}, and non-response counters 60, Cnr, are initialized at 0. The other counters of general history, Cgh, and of dialog level, Cₗₑᵥ, retain their value from the preceding main question 20. Each main question 20 might cause the user to (1) ask so-called secondary questions elucidating his/her request or (2) answer questions (i.e., second user answers) raised by the voice navigation system 1. When a question or a secondary reply is formulated, the values of the incomprehensibility counter C_{inc} and non-response counter Cnr are not reset to 0.

The analysis 21 carried out the analysis engine 13 can lead to several conclusions:

(1) The analysis may be complete and confirmed 22. In this event, no additional confirmation is requested from the user. The dialog management causes the vocal application 12 to successfully offer an answer 24 to the user's main question 20. In a second stage 23, the voice application 12 also commands updating of the counters by decrementing by 1 the dialog counters Cₗₑᵥ and the general history counters Cgh. In case the main question 20 is the session's first question, the dialog level counters Cₗₑᵥ and the general history counters Cgh remain at 0. The voice application 12 in this second stage 23 initializes to 0 non-response counter Cnr and incomprehensibility counter Cgh. This initialization flows from the fact that these are local counters and must be initialized 60 in response to each new main question 20 a user asks.

(2) The analysis 21 also might be inconclusive 32, that is, the analysis engine 13 did not sufficiently understand the main question for the voice application 12 to successfully reply 24 to the question. In this case and by means of the dialog management, the voice application in a third stage 33 transmits, via the voice interface 2, a confirmation request to the user. The confirmation request regards the question the analysis engine did not properly understand. In a fourth stage 34, the requester provides a secondary response by confirming his/her question indeed was involved, or by negating:

(a) in the event the user confirms, for instance by saying “yes” 35, into the voice interface, then, by means of the dialog management, the voice application 12 offers a reply 24 to the main question 20 raised by user and updates the counters in the light of the second stage (23),

(b) if the user does not confirm the suggestion advanced by the voice navigation system, for instance by replying “no” 36, then, in a fifth stage 37, the voice application 12 command modifies the help level by incrementing the dialog level counter Cₗₑᵥ for instance by 2; the other counters remain at their preceding values. The help level 38 remains at this value until a new modification occurs during the remainder of the session. In case the main question is the first one of the session, the dialog level counter Cₗₑᵥ is then storing a value of 2. Accordingly the level of help has increased and the user then is led to formulate a secondary question. Because this is a secondary question, the non-reply counter Cnr and incomprehensibility counter Cgh[??? C_{inc} ???] are not reset to 0. This secondary question is analyzed by the analysis engine 13 during the first stage 21.

(3) Analysis 21 may lead to incomprehensibility 42 as seen by the analysis engine 13. In this case and in a sixth stage 43, the application at once commands incrementation, illustratively by 1, of the incomprehensibility counter C_{inc}. In a sixth stage 44, the voice application 12 compares the value of the incomprehensibility counter C_{inc} with the maximum value INCmax this counter can store.

(a) If the value the incomprehensibility counter value C_{inc} stores is less than the stored maximum value, for instance 2, then, in an eighth stage 45, the voice application 12 commands sending to the user through the voice interface 2 a request for repetition. The repetition carried out by the user is analyzed by the voice recognition engine 11 and then, during the first stage 21, by the analysis engine 13. The non-response and incomprehensibility counters Cnr and C_{inc} are not reset to 0 because this is a secondary question rather than a main question.

(b) If the value stored in the incomprehensibility counter C_{inc} is larger 44 than the stored maximum value INCmax, then, in a ninth stage 55, the voice application 12 compares the value of the general history counter Cgh with its stored maximum value Ghmax.

If the value stored in general history counter Cgh is less than the stored maximum value GHmax, for instance 3, then the fifth stage 37 is carried out. During fifth stage 37 the assistance or help level is controlled by the voice application 12 while the dialog level counter Cₗₑᵥ is incremented;

If the value stored in general history counter Cgh exceeds the stored maximum value GHmax, then there is failure 57 and no answer is sent in response to the main user question 20. In this case, the voice application 12 connects the user to a remote actor. In this way the user is sent to a physical person who can help him/her even more. In all cases this referral is carried out before the user tires and breaks off the communication.

(4) Analysis can lead to the conclusion that no spoken words 52 were entered by the user to the voice interface 2. In this case and in a tenth stage 53, the voice application 12 commands the general history counter Cgh to be incremented by one and the non-response counter Cnr to be incremented by one. In eleventh stage 54, the voice application 12 compares the new value of the non-response counter Cnr with the stored maximum value NRmax:

(a) If the value of the non-response counter Cnr is less than the stored maximum value NRmax, then, in a twelfth stage 56, the voice application 12 works out and sends to the user a request for discussion. The new spoken words of the user are analyzed by the speech recognition engine and thereupon, during the first stage 21, by the analysis engine 13. These new words form a secondary question and accordingly none of the counters is reset to 0.

(b) If the value of the non-response counter Cnr exceeds the stored maximum value NRmax, the ninth comparison stage 55 discussed above is performed.

Consequently the voice navigation system of FIGS. 1 and 2, by means of its voice interface, utters shorter sentences for more experienced users who require less help. In case the user hesitates or cannot be understood by the speech recognition engine 11 or by analysis engine 13, the help level is increased in a way to provide detailed texts and explanations. The voice navigation system of FIGS. 1 and 2 circumvents dialogs that do not contribute to the search. The incomprehensibility and non-response counters are used to limit the number of loops and the presence of the general history counter make it possible, once the stored maximum value for the latter counter has been exceeded, to refer the user to a remote actor, i.e., real person.

It should be clear to those of ordinary skill that the present invention allows embodiment modes in many other specific designs without thereby transcending the domain of application of the present invention as it is claimed. Therefore the present embodiment must be deemed illustrative while allowing modification within the field defined by the scope of the attached claims, and the invention may not be limited by the details disclosed above.

1. An adaptive navigation method in an interactive voice system (1) including a recognition engine for a user's spoken words, a voice application stored in a memory of a central processing unit of a data system, the method comprising managing via a dialog manager the dialog with the user through an interface as a function of the implemented recognition, and adjusting the voice application as a function of a plurality of indicators linked to the user behavior and represented by data stored in the memory of the central processing unit by ergonomically dynamically managing the dialogs with the user.

2. The method of claim 1, further comprising analyzing the implemented recognition and initiating an action managed by the voice application as a function of the analyzed implemented recognition and the state of at least one of the indicators.

3. The method of claim 2, wherein said action includes either (a) sending a reply to the spoken words of a user or a request to the user to repeat the user's spoken words to a request to the user to talk, or (b) relaying the user to consultation with a physical person, or modifying a help level to offer the user.

4. The method of claim 2, further comprising sending a confirmation request of the implemented recognition prior to initiating said action.

5. The method of claim 4, further comprising responding to dialog with the user to store a first indicator representing the user's dialog level, a second indicator based on dialog quality, and a third indicator representing the history of the dialogue with the user.

6. The method of claim 5, further including incrementing the first indicator in response to a modification of a help level.

7. The method of claim 5, further including incrementing a non-response indicator in response to (a) the non-response indictor being at a value less than a maximum value (NRmax) and (b) sending of a request for talk to the user.

8. The method of claim 5, further including incrementing an incomprehensibility indicator in response to (a) the incomprehensibility indicator being less than a maximum value and (b) sending of a request for repetition to the user.

9. An interactive voice navigation system comprising an engine for recognizing a user's spoken words, a voice application stored in a memory of a central processing unit of a data system, the processing unit being arranged for managing dialog with the user through a voice interface as a function of the implemented recognition, and (b) ergonomically dynamically managing the dialogs with the user by adjusting the voice application as a function of a plurality of indicators associated with user behavior and represented by data stored in the memory of the central processing unit.

10. The system of claim 9, wherein the processor is arranged for (a) implemented recognition analyzing and (b) initiating an action managed by the voice application as a function of the analysis of the implemented recognition and the state of at least one indicator.

11. The system of claim 10, wherein the processor is arranged for working out and sending a reply to spoken words from the user, (b) confirming a request to a user to repeat the spoken words of the user or a request to a user to talk having been worked out and sent, (c) switching the dialogue to a physical person, and (d) regulating a help level to offer to the user.

12. The system of claim 9, wherein the processor is arranged for deriving (a) a first indicator representing the level of the user's spoken words, (b) a second indicator representing the quality of the dialog, and (c) a third indicator representing the history of the dialog with the user.

13. The system of claim 12, wherein the processor includes a counter for storing each indicator and for incrementing the counter in response to dialog with the user.

14. The system of claim 13, wherein the first indicator is associated with a dialog-level counter in the memory of the processor, the processor being arranged to initiate a modification of the help level in response to the dialog-level counter being incremented or decremented.

15. The system of claim 13, wherein the processor memory includes a first local incomprehensibility counter for storing the second indicator and a second local non-response counter.

16. The system of claim 13, wherein the processor memory includes a general history counter for storing the third indicator.

17. The system of claim 14, wherein the dialog-level counter can store values only from 0 to 4.

18. The system of claim 15, wherein the incomprehensibility counter can store values from 0 to a value exceeding its stored maximum value which is 2.

19. The system of claim 15, wherein the non-response counter can store values from 0 to a value exceeding a stored maximum value which is 2.

20. The system of claim 16, wherein the general history counter can store values from 0 to a value exceeding a stored maximum value which is 3.

21. A mobile telephony system including the system of claim 9.
